(19) United States
(12) Patent Application Publication
(10) Pub. No.: US 2013/0137136 A1
(43) Pub. Date: May 30, 2013

(54) METHOD AND SYSTEM FOR AUTOMATED DEPARAFFINIZATION AND NON-IMMUNOHISTOCHEMICAL SPECIAL STAINING OF TISSUE SAMPLES

(71) Applicants: Debra Cobb, Saugus, CA (US); Robin Beard, Ventura, CA (US)

(72) Inventors: Debra Cobb, Saugus, CA (US); Robin Beard, Ventura, CA (US)

(73) Assignee: Dako Denmark A/S

(21) Appl. No.: 13/690,015

(22) Filed: Nov. 30, 2012

Related U.S. Application Data
(60) Provisional application No. 61/565,209, filed on Nov. 30, 2011.

(51) Int. Cl. G01N 1/30

(52) U.S. Cl. CPC G01N 1/30
USPC 435/40.5

(57) ABSTRACT

Disclosed are methods and systems for automated deparaffinization and histochemical staining of tissue samples. Samples are automatically deparaffinized and stained without the use of harsh chemicals and without the use of extreme temperatures.

### RELATED APPLICATIONS

This application claims the benefit of priority under 35 U.S.C. §119(e) of U.S. Provisional Patent Application No. 61/565,209, filed on Nov. 30, 2011, the disclosure or which is hereby incorporated by reference.

### FIELD OF THE INVENTION

The present disclosure relates to methods and systems for automated deparaffinization and non-immunohistochemical special staining of tissue specimens.

### BACKGROUND

Advances in analytical science have made it possible to extract a wide variety of information from a biological specimen. For example, it may be possible to assess the health, diagnose a disease state, identify possible future health issues, predict a response to a treatment, and provide information related to the genetic makeup of an individual from which the specimen was obtained.

Histochemical staining has made it possible to highlight morphological features of a specimen and in some cases to detect and visualize the presence of target molecules with a specimen.

Special stains are “special” because they are not routine. They are applied to tissue sections in addition to hematoxylin and eosin (H&E)-stained sections to answer questions that arise above and beyond those that can be answered by interpreting H&E-stained tissue morphology. The term “special stains” is of uncertain provenance, but one can be certain that it began to be used after 1876 when H&E was introduced.

Various automated stainers exist which automate certain staining protocol steps. Some protocol steps may be performed manually prior to automated processing of the samples by an automated stainer.

Reagents for various protocol steps may be dispensed from bulk reagent containers or from reagent container design to provide sufficient reagents to perform a defined number of tests for a specified protocol.

Tissue samples are often embedded in paraffin to preserve testable characteristics of the samples. Prior to histochemical staining, tissue samples are deparaffinized in order to facilitate access of the staining reagents to the tissue components.

### SUMMARY

An embodiment of the invention may comprise a method of automatically deparaffinizing and performing special staining of paraffin embedded tissue samples comprising: a) loading a first microscope slide comprising at least one paraffin embedded tissue sample in a horizontal position or substantially horizontal position, such as with 10° of horizontal, onto an automated stainer that performs special stains compromising a robotic reagent dispenser such as a dispensing carousel; b) dispensing a covering volume of a non-buffered aqueous deparaffinization fluid comprising water and a water-miscible paraffin solvent onto said first microscope slide such that said tissue sample is covered by said deparaffinization fluid; c) automatically controlling the temperature of said first microscope slide to a programmed temperature of between about 50° C. and about 60° C. for a programmed time sufficient to dissolve the paraffin, such a less than about 11 minutes; d) robotically removing paraffin together with deparaffinization fluid from said tissue sample; e) dispensing a covering volume of clearing fluid onto said slide; f) automatically controlling temperature of said slide to a programmed temperature of between ambient and about 40° C. for a programmed time, for example, of less than about 4 minutes; g) robotically removing said clearing fluid from said slide; and h) staining said tissue sample by moving, such as rotating said reagent dispenser or dispensing carousel to a position above said tissue sample and dispensing a special staining reagent onto said tissue sample.

Another embodiment of the invention may comprise a method of automatically deparaffinizing and performing special staining of paraffin embedded tissue samples comprising: a) loading a first microscope slide comprising at least one paraffin embedded tissue sample in a horizontal position onto an automated special stainer compromising a robotic reagent dispensing carousel; b) placing a fluid retaining clip onto said first microscope slide; c) dispensing a covering volume of a non-buffer aqueous deparaffinization fluid comprising water and a water-miscible paraffin solvent onto said first microscope slide such that said tissue sample is covered by said deparaffinization fluid that is retained by said fluid retraining clip; d) automatically controlling the temperature of said first microscope slide to a programmed temperature of between about 50° C. and about 60° C. for a programmed time of less than about 11 minutes; f) removing paraffin from said tissue sample by robotically aspirating said paraffin together with said deparaffinization fluid from said tissue sample; g) dispensing a covering volume of clearing fluid onto said slide; h) automatically controlling temperature of said slide to a programmed temperature of between ambient and about 40° C. for a programmed time of less than about 4 minutes; i) robotically removing said clearing fluid from said slide; j) staining said tissue sample by rotating said reagent dispensing carousel to a position above said tissue sample and dispensing a special staining reagent onto said tissue sample.

### BRIEF DESCRIPTION OF THE DRAWINGS

FIG. 1 is an illustration of an automated special staining system.

FIG. 2 is a close up view of reagent and slide carousels.

FIG. 3 is a flow chart of a method of automated deparaffinization.

FIG. 4 is a chart showing results of a first special staining quality system assessment comparing ACS, xylene and hot wash methods of deparaffinization.

FIG. 5 is a chart showing results of a second special staining quality system assessment comparing slides stained using three methods of deparaffinization: xylene; 2% ACS; and 2% ACS with automated drying performed on the automated system prior to deparaffinization.

FIG. 6 compares residual paraffin under polarized light for tissue prepared using ACS deparaffinization and tissue prepared using hot wash deparaffinization.

FIG. 7 compares residual paraffin under polarized light for tissue using ACS deparaffinization with various concentrations of water miscible paraffin solvent, various clearing steps at specified temperature and times, and mounting with aqueous and permanent coverslip mounting.

FIG. 8 shows images for comparison of staining quality of permanent mounted slides with tissues deparaffinized using ACS deparaffinization with various concentrations of water miscible paraffin solvent and for tissue deparaffinized manually using xylene.

### DEFINITIONS

As used herein, the term “special stains” broadly refers to any one of many techniques for staining specimens for microscopic evaluation which does not involve the stain routinely used for that discipline, and which is usually selected to demonstrate a special structural, chemical, or molecular characteristic of the tissue. For example, Hematoxylin and Eosin, also known as H&E is the routine stain for surgical pathology; so other histochemical stains which are not immunohistochemical stains (e.g. iron stain, trichrome) are known as special stains.

### DETAILED DESCRIPTION OF THE EMBODIMENTS

Automated Dewaxing for Special Stainers

Preferred embodiments of the invention are directed to automated dewaxing of paraffin embedded on an automated special stainer. The various embodiments of the invention described provide dewaxing reagents and methods that offer at least one of the following characteristics that provide advantages over other dewaxing technologies. These characteristics may include, for example:

1) provides an automated solution that effectively removes paraffin from paraffin embedded tissue specimens as well as, or better than historical xylene-based manual deparaffinization;

2) results in staining quality that meets or exceeds pathologists' requirements and expectations including: clear visual differentiation of the intended target tissue component, reproducibility of staining results, minimal background, minimization of paraffin related staining artifacts;

3) minimizes the number of specimens that have to be replaced and re-stained due to negative effects of extreme heating, harsh chemical solvents, and aggressive agitation used to deparaffinized tissue;

4) provides a system that facilitates easy automation of manual special staining protocol steps including staining times and temperatures without necessitating major reworking of the protocols to meet a fixed or significantly limited set of processing temperatures;

5) minimizes the time require for automated dewaxing;

6) reduces the cost of dewaxing reagents;

7) minimizes the negative environmental and occupational safety hazards associated with harsh chemicals historically used in dewaxing;

8) provides a automated staining solution with minimal fire hazard;

9) eliminates the use of dewaxing solvents that harm or deteriorate tubing, seals, gaskets and other materials otherwise suitable for fluid conveyance in an automated staining system;

10) minimizes the need for special stainer cleaning and maintenance to remove residues related to automated deparaffinization.

In order to appreciate the needs recognized by the applicant and provided by embodiments of the claimed system and methods, it is helpful to understand the unique requirements of an automated special stainer in comparison with requirements of other types of tissue specimen stainers such as for example H&E stainers and IHC stainers

Broad Range of Special Staining Protocols Leads to Unique Automation Requirements

Special stains in anatomical pathology are diverse and thus have different protocols. Historically, special stains have often been developed in a custom way to meet the needs and preferences of the pathologists who analyze the stained tissue. While the benefits of automated slide staining such as reproducibility of staining results and reduced human error are desirable in special staining, automation more than one or a few special stains on a single instrument is relatively more challenging and complex because a broader range of processing reagents, temperatures, and timing is required.

Tissue specimens are frequently fixed in formalin and embedded in paraffin in order to preserve the structure and biochemical content of the specimen. However, in order to stain the tissue, the paraffin is almost always removed and in some cases specimens are pretreated to enhance access to the target components.

While it is generally desirable to minimize the effects of fixation and paraffin embedding for many types of staining, it is difficult to completely avoid such effect. Therefore the best that can be achieved is often to standardize the pretreatment and staining protocols to the point that the effects can be made relatively predictable. For staining of tissue specimens using immunohistochemical staining and H&E staining, this is relatively easier due to the fact that typically all H&E slides are processed using essentially the same protocol with the same reagents. Likewise, immunohistochemistry staining of slides involved the same protocol steps, timing and temperature with the key difference being the antibody applied.

However, with special stains the timing and temperature of the protocol steps for different special stains can vary significantly. Although some have sought to automate special staining by modifying the original protocols to conform to a unified set of processing steps, times, and temperatures, such a strategy may have disadvantages such as for example that in order to modify a special staining protocol to work under a unified automated processing protocol it takes significantly more experimentation and effort that to automate a protocol where the automated stainer is capable of flexible programming of time and temperature.

Therefore, it is desirable to provide an automated deparaffinization method suitable for use in a system that provides flexible time and temperature capabilities

Flexible Automated Special Stainer

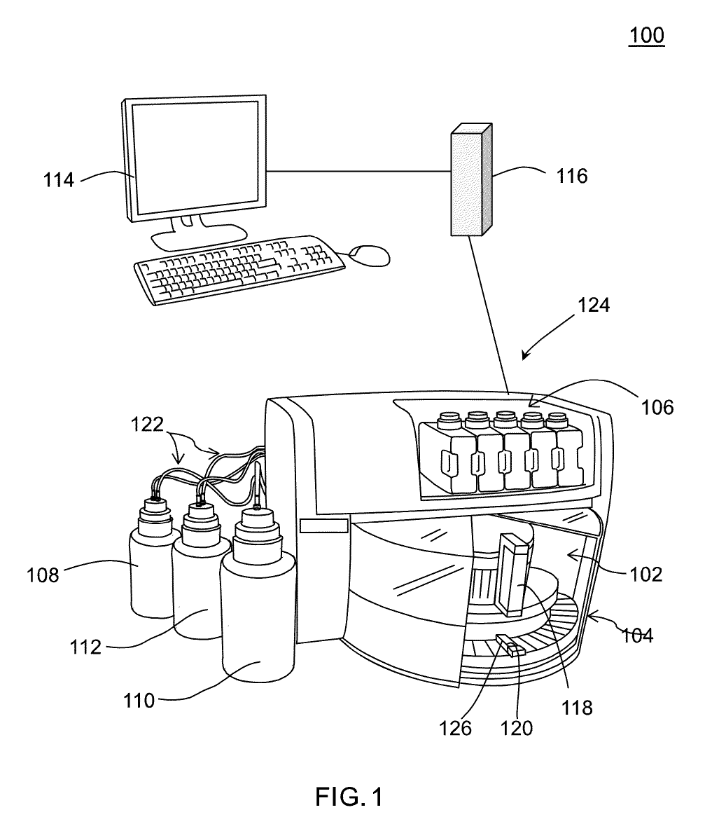

FIG. 1 illustrates an automated special staining system 100 that has flexible programming of time and temperature designed to be suitable for special staining using a fairly broad range of stains and staining protocols. Examples of such special staining systems are further described in U.S. Pat. No. 6,183,693, U.S. Pat. No. 6,541,261, U.S. Pat. No. 6,783,733, U.S. Pat. No. 7,217,392, and U.S. Pat. No. 7,553,672, all of which are incorporated by reference.

The automated special staining system 100 may comprise a workstation 116 (e.g. a PC, server, network device) that interfaces with special stainer 124. Data such as staining protocols, schedules, status, or any data associated with at least one stainer 124 may be entered, displayed, or otherwise communicated at input/display 114. Processing workstation may which may be remote to, or other may include a reagent carousel 102 and a slide carousel 104 which are adapted to efficiently dispense the special staining reagents (e.g. stains in a dispense pack 118) on to specimens on slides 120. Bulk reagents containers 106 hold reagents used in staining such as wash solutions, clearing reagents such as ethanol, deionized or distilled water.

Another issue which is particularly relevant to automated special stainers is the requirement for evaporation mitigation. Special stainer 124 provides evaporation mitigation by dispensing an amount of reagent sufficient to mitigate evaporation (e.g. 2000 μL-3000 μL) into individual reagent wells or retaining clips 126 that clip atop the slide. This arrangement, may be mechanically simpler than attempting to mechanically cover the slide with a glass cover slip, and may also result in fewer residues to be dealt with than so-called liquid coverslip comprising mineral oil/paraffinic hydrocarbons.

Automated special staining system 100 may also connect to a server 116 or similar computer system that connects to a control display 114 at which an operator of the system may program, select, monitor or otherwise interface with special staining system 100.

Within embodiments of the invention, deparaffinization fluid that provides one or more of the advantages previously described may be held by a dispense pack such as dispense pack 118 or alternatively in a bulk reagent container such as bulk containers 106 and dispensed robotically to specimens on slides 120.

Expended and excess reagents including stains may be segregated according into hazardous waste such as metals, combined dyes, and flammable waste such as alcohol, and water soluble waste. These excess reagents are transported through fluidic conduits (i.e. silicone tubing) 122 to waste containers 108 (trace metals), 112 (combined dyes), and 110 (water soluble waste).

Embodiments of the invention may include deparaffinization fluid comprising a mild water-miscible paraffin solvent that is mixed with wash solution in a concentration sufficiently dilute to permit used deparaffinization fluid to be safely discarded into the water soluble waste container 110. This deparaffination fluid is also referred to as ACS.

Special stainer 124 includes bulk fluid containers 106. Bulk fluids may be dispensed from bulk fluid containers robotically via fluidic control mechanisms at a bulk fluid dispensing station. Special stainer 124 may also include a mixing station where a robotic head mixes fluids. Special stainer 124 may further include a station where an aspiration foot on a robotic head aspirates liquid away from the slide. Further details regarding the structure and operation of bulk fluid robotic dispensing, robotic mixing and robotic fluid aspiration are provided in the aforementioned patents which are incorporated by reference.

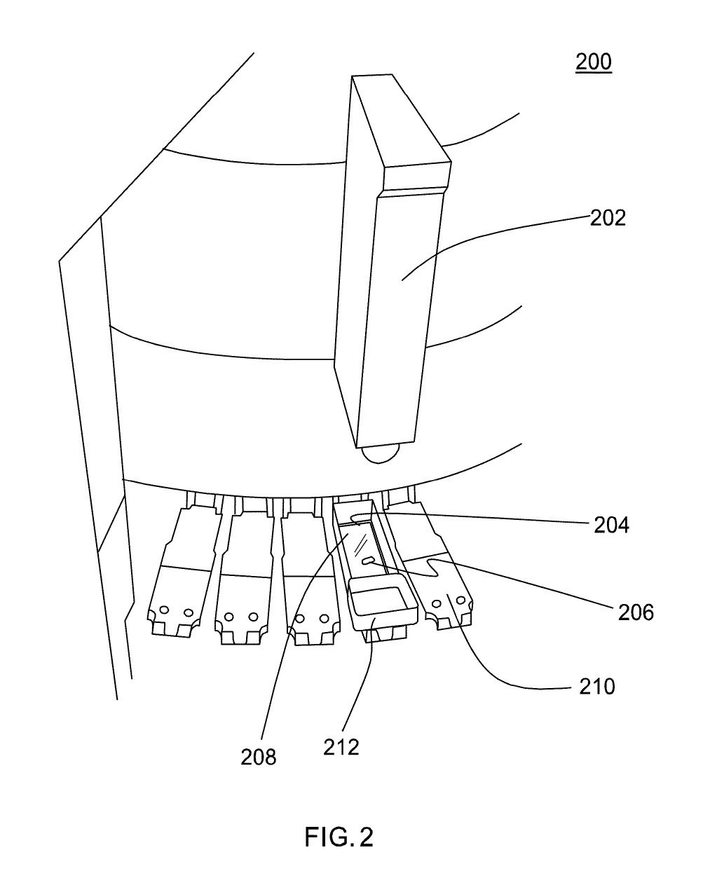

FIG. 2 is a close-up view of an automated special staining system 200 that includes a reagent carousel adapted to efficiently dispense special staining reagents in dispense packs such as dispense pack 202. Dispense pack 202 is robotically brought to a reagent dispense location (for example a location near the center rear of the carousel where reagent is robotically dispensed onto a slide below the dispenser).

Mild Non-Deteriorating Deparaffinization Fluid does not Deteriorate Elastomeric Materials Used in Automated Special Staining Systems.

In preferred embodiments of the invention, deparaffinization fluid comprising water-miscible solvent may be dispensed from a reagent dispenser such as reagent dispenser 202. In further preferred embodiments, a water-miscible paraffin solvent, i.e. ACS, comprising 2% 2-butoxyethanol or similar water-miscible paraffin solvent in a wash solution or another aqueous solution may be dispensed directly from dispenser 202. In other embodiments, a water-miscible solvent comprising 2-butoxyethanol or similar water-miscible paraffin solvent in a higher concentration, for example a 4% solution may be dispensed after which the deparaffinization fluid may be further diluted to, for example 2%, with wash solution or another aqueous fluid dispensed from a bulk reagent container. In embodiments where the deparaffinization fluid is dispensed in a concentration to be further diluted, robotic mixing of the fluid and the aqueous diluting agent may be performed to ensure even concentration and coverage of the tissue specimen on the slide.

Harsher solvents such as xylene, hexane, aliphatic hydrocarbons, terpenes, limonene and similar non-polar organic solvents may partially dissolve or deteriorate materials (e.g. silicon) used in the dispenser valves, seals, packaging and so forth which may result in leakage.

In contrast, embodiments of the invention, i.e. ACS comprising deparaffinization fluid that includes a mild water-miscible paraffin solvent such as 2-butoxyethanol or equivalents, have been tested in dispense packs for more than 4 months with no leakage and no deterioration of the dispenser valve, seals, or packaging. Although other materials more resistant to such deterioration might be used, many of the more resistant materials with the proper elasticity and sealing characteristics are more expensive than materials suitable for dilute aqueous deparaffinization fluids comprising water miscible paraffin solvents as provided in the embodiments of the invention.

In other embodiments, a water-miscible solvent comprising 2% 2-butoxyethanol or equivalents in a wash solution or another aqueous solution may be dispensed directly from dispenser 202.

In further embodiments, dispense pack 202 may contain cleaning or maintenance fluids for cleaning automated special staining system 200 between tissue processing protocols.

Also illustrated in FIG. 2 is a microscope slide 208 with a tissue specimen 206. Slide 208 rests upon a heater 210 that is sufficiently smooth and sufficiently planar to enable the slide to rest sufficiently firmly upon heater 210 so as to enable efficient and even thermal transfer of heat from heater 210 to slide 208, specimen 206 and any reagent or fluid covering slide 208.

As described above in the description of FIG. 1, evaporation mitigation may be important to prevent any part of tissue specimen 206 from drying out and to maintain reagent concentration within an acceptable range i.e. not too high of concentration resulting from evaporation of water within the fluid during heating.

In preferred embodiments, the evaporation mitigation may comprise dispensing a volume of reagent sufficient to mitigate evaporation (e.g. 2000 μL-3000 μL) into individual reagent retaining clips such as reagent clip 212 atop the slide. Reagent clip 212 also enables the slide to rest firmly upon the heater such as heater 210 so as to permit efficient and even thermal transfer. To avoid leakage of reagents, slide clip 212 may comprise a sealing gasket 204 to prevent leakage of fluid during processing including during heating.

As mentioned before, harsh organic solvents such as xylene, hexane, aliphatic hydrocarbons, terpenes, limonene and similar non-polar organic solvents may partially dissolve or deteriorate materials (e.g. silicon) used in gasket 204, thereby resulting in leakage.

However, embodiments of the invention comprising deparaffinization fluid that includes a mild water-miscible paraffin solvent such as 2-butoxyethanol or equivalents have also been tested in contact with slide clip gaskets for more than 4 months with no leakage and no deterioration.

In other embodiments, evaporation mitigation may include robotically dispensing an evaporation inhibiting liquid comprising water immiscible fluids such as mineral oil or other hydrocarbons onto slides to cover aqueous reagents during heating and inhibit evaporation of the aqueous reagents. Of course the cost of such oily evaporation inhibitors must be accounted for.

In systems where deparaffinization fluid does not include water-miscible paraffin solvent that directly contacts the paraffin embedded tissue specimen, robotically dispensing oily evaporation inhibiting liquids may result in a requirement for periodic cleaning of residual oil from the system.

Embodiments wherein deparaffinization fluid that comprises water miscible paraffin solvents such as 2-butoxyethanol and equivalents that directly contact tissue specimens, which also include an oily evaporation inhibitor, may require less periodic cleaning to remove oily residue because the paraffin solvent also assists in carrying such residue away.

Method of Automated Special Staining Comprising Automated Deparaffinization.

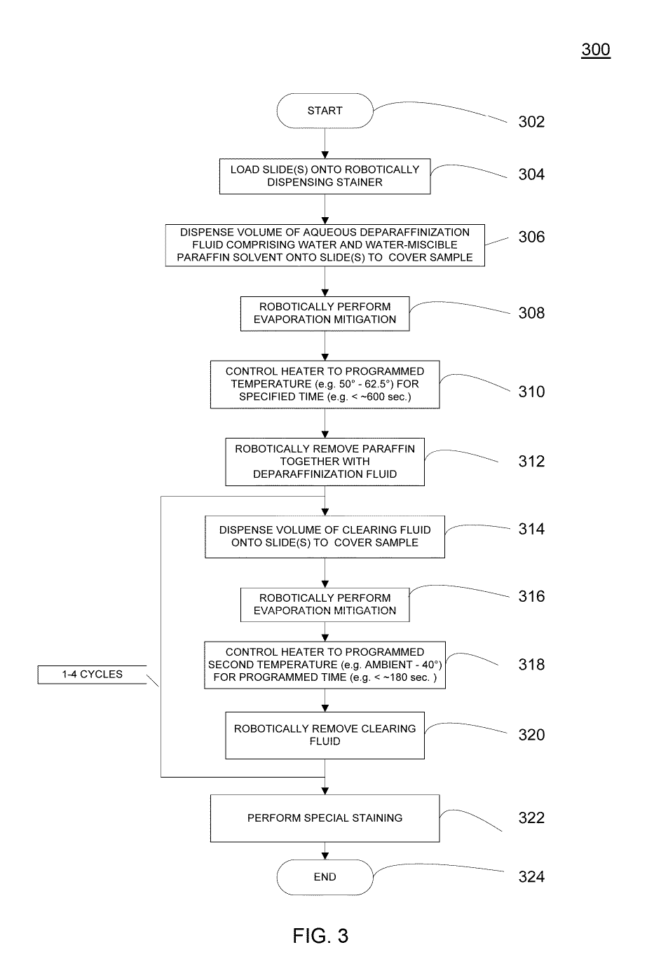

FIG. 3 is a chart illustrating an embodiment of the invention which is a method of automated special staining comprising automated deparaffinization. After the start step 302, at least one slide is loaded onto a robotically dispensing stainer (e.g. special stainer 124 illustrated in FIG. 1 or similar stainer) at step 304.

At step 306, aqueous deparaffinization fluid comprising water and water-miscible paraffin solvent is dispensed onto slides to cover a biological tissue sample.

At step 308, evaporation mitigation is performed robotically, for example by dispensing a sufficient volume of fluid into a fluid retaining clip to mitigate evaporation or by robotically dispensing an evaporation inhibiting fluid onto a slide or by robotically placing an evaporation cover over the fluid.

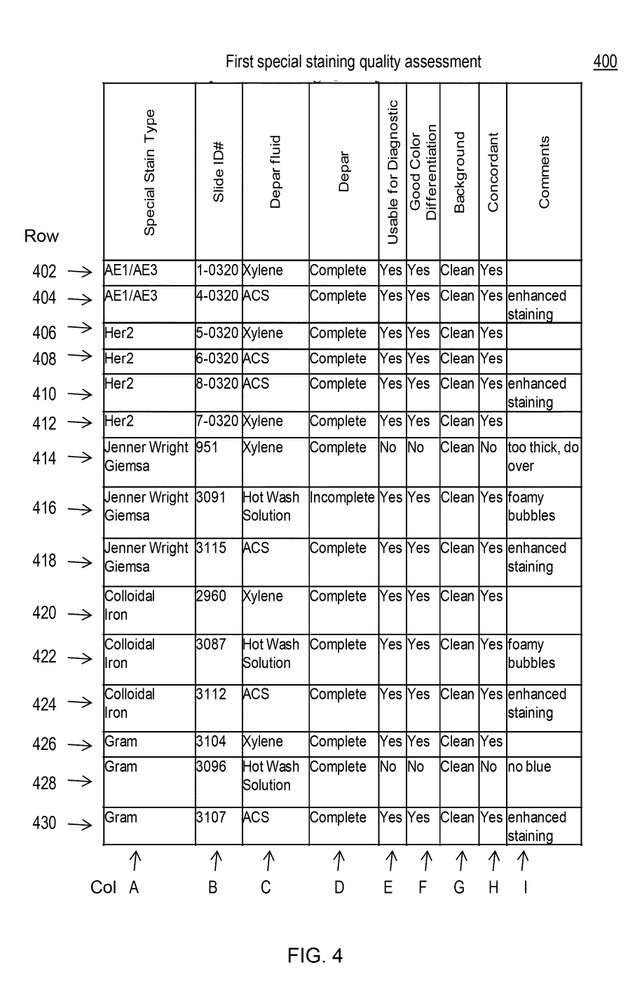

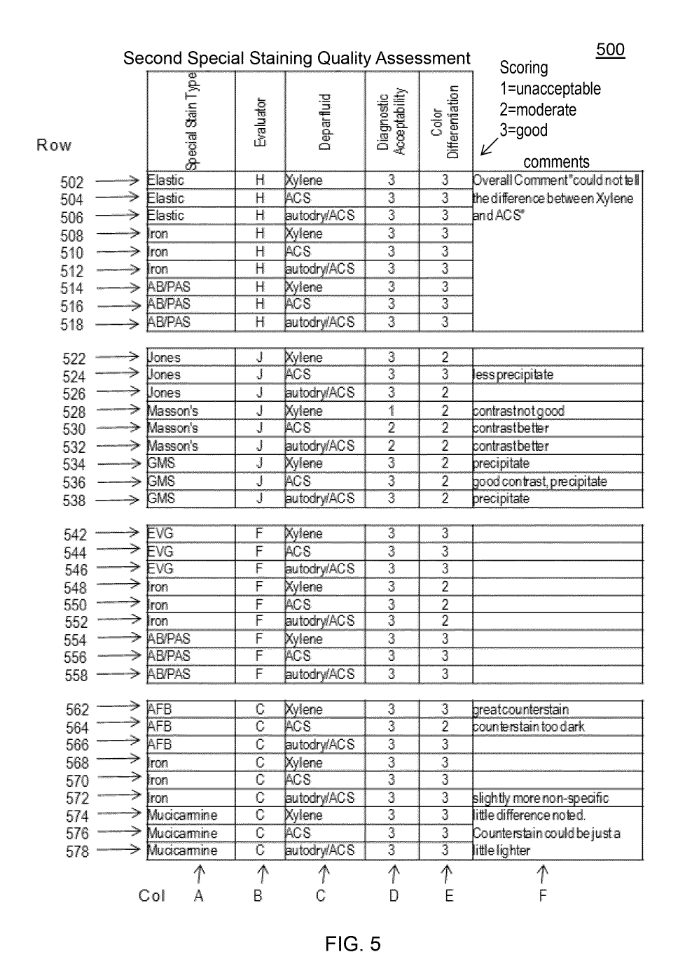

At step 310, at least one heater is automatically controlled to a programmed temperature for a specified time. For example, in embodiments of the invention, the heater is controlled to a temperature of between 50° C.-62.5° C. for a time of about 10 minutes. Experiments demonstrate that 10 minutes heating in deparaffinization fluid comprising a water-miscible paraffin solvent such as 2-butoxyethanol or equivalents results in deparaffinization that is as good or better than manually deparaffinization and significantly better than in deparaffinization for 25 minutes in hot aqueous fluid comprising a surfactant. These results are described in more detail in the description of FIG. 4—Special Staining Quality Assessment 2. Similar results are described in FIG. 5—Special Staining Quality Assessment 2.

At step 312, the paraffin which was removed from the tissues specimen by the heated water-miscible paraffin solvent is robotically removed. In some embodiments, the paraffin is robotically removed by aspirating, i.e. suctioning the dissolved paraffin away from the slide and into the waste fluid disposal system. This robotic aspiration removal method sucks away the paraffin from the fluid above the tissue without the robotic aspiration foot touching the tissue sample and without applying any force against the tissue. In other embodiments, the paraffin may be robotically removed by spray rinsing to sweep the paraffin away from the slide. However, the spray rinsing method of robotic paraffin removal may leave a small amount of residual paraffin on the tissue unless spray rinsing is performed vigorously or multiple times. Care should be taken to avoid applying too much force during spray rinsing since this may increased risk of dislodging the tissue section.

At step 314, a volume of clearing fluid, e.g. ethanol or a paraffin-immiscible wash solution including a surfactant, is dispensed onto the slide to cover the sample.

At step 316 evaporation mitigation is robotically performed, e.g. adding sufficient volume to mitigate the effects of evaporation or applying an evaporation inhibitor such as a film of oily evaporation inhibitor or robotically placing an evaporation cover over the fluid.

At step 318, with sufficient fluid to mitigate evaporation or with other evaporation mitigation in place, a heater is controlled to a second programmed temperature lower than the first heating temperature used in step 310, for example at this step the second temperature may be controlled to 40° C. for a specified time e.g. 180 seconds.

At step 320, the clearing fluid, which may, for example, be ethanol or a paraffin immiscible fluid including a surfactant, is robotically removed, e.g. by aspirating or by robotically spray rinsing or any other suitable robotic removal means.

Steps 314, 316, 318, and 320 may be repeated as many times as desired and the clearing solution dispensed in step 314 may be the same as in the first iteration or may be different. Also, the step of controlling the heater to a second temperature may be held constant with each iteration or may be changed for iterations with the second temperature being lower than the first temperature at step 310.

In one embodiment, 100% ethanol is dispensed at first iteration of step 314 with sufficient volume being added to mitigate evaporation during heating. Temperature is controlled to about 40° C. for approximately 180 seconds. Then the clearing fluid is robotically removed and the process is iterated. In the second iteration, 100% ethanol is used again only this time the temperature is controlled passively to ambient i.e. by turning off the heater. This allows the slide to begin cooling. A third iteration is performed using 95% ethanol at ambient with the robotic fluid removal being performed without delay i.e. as soon as the previous step is completed. Afterwards additional iterations, such as a fourth, fifth, sixth, and up to a seventh iterations may be performed using wash solution which is a paraffin-immiscible aqueous fluid including a surfactant.

At step 322, special staining may be automatically performed according to a programmed special staining protocol after which the specimen may be evaluated. Finally, at step 324, the method of automated special staining including automated deparaffinization may be completed.

In some embodiments consistent with the present disclosure, automated special stainer 200 may include a maintenance or cleaning regime, performed at user configurable intervals between the automated processing of tissue specimens. A

maintenance or cleaning regime may include the use of a cleaning solution or fluid packaged in a dispenser pack 202 and loaded into the automated special stainer reagent carousel 102. The cleaning solution or fluid may be a concentrated cleaning solution or fluid. A maintenance or cleaning regime may also include the use of a blank, or dummy, slide 208 to facilitate the procedure. In such a regime, automated special stainer 200 may dispense cleaning solution from dispenser pack 202 to clean the elements of automated special stainer 200 that carry fluid under normal operation. For example, the cleaning solution may be employed to clean a robotic aspiration foot, fluid conveyance tubing, seals, gaskets, valves, and any other features of automated special stainer 200 subject to residue build-up from the fluids used during specimen processing protocols. Use of a maintenance or cleaning regime may prevent residue build-up and subsequent clogging of fluid transfer elements. In the event of clogging, use of a maintenance or cleaning regime may serve to eliminate the clogs.

Automated special stainer 200 may be configured by a user to perform a maintenance or cleaning regime at specified intervals, for example, after processing a specified number of slides or at a certain time each day, week, or month. Automated special stainer 200 may be configured to alert a user to the number of slides processed between cleanings and that a cleaning is due. Automated special stainer 200 may be configured to automatically initiate a scheduled cleaning regime as soon as the specified interval has passed and may be configured to require a user to initiate a scheduled cleaning regime. Automated special stainer 200 may be configured so as not to begin any specimen processing protocols when a cleaning regime is required. Automated special stainer 200 may be configured with a default interval between cleanings, for example, 50, 100, 150, or 200 slides.

FIG. 4 shows results of a first special staining quality assessment 400. In the first special staining quality assessment, an expert pathologist examined fifteen slides stained with various special stains. Three deparaffinization methods were compared: manual deparaffinization with xylene; automated deparaffinization using hot wash solution, i.e. a paraffin immiscible fluid including a surfactant heated to 62.5° C. for 10 to 15 minutes; and deparaffinization using ACS i.e. a deparaffinization fluid comprising a water-miscible paraffin solvent e.g. 2% 2-butoxyethanol.

Assessment of tissue samples deparaffinized using xylene is shown at rows 402, 406, 412, 414, 420, and 426. With the exception of 414 the results of the xylene deparaffinized samples were: usable for diagnostic purposes as shown in column E; had good color differentiation as shown in column F; were generally clean from background staining as shown in column G; and were concordant as shown in column H, i.e. matched the expected staining results of these positive control specimens.

As shown in rows 404, 408, 410, 418, 422, 424, and 430, the staining results of tissues deparaffinized using ACS deparaffinization method described in FIG. 3 and the corresponding description were at least as good as those specimens stained after deparaffinization using xylene. As shown in row 404, 410, 418, 424, and 430, the pathologist assessed that the staining of the ACS deparaffinized slides was enhanced compared to that of the xylene slides.

The third deparaffinization method tested was hot wash solution, i.e. deparaffinization using a paraffin immiscible aqueous fluid comprising a surfactant was heated to 62.5° C. for 25 minutes and clearing steps were performed additional fluid added and removed. In other words, steps corresponding to the steps of the ACS method were performed but wash solution (surfactant and DI water) was used instead of ACS deparaffinization fluid comprising a water miscible paraffin solvent e.g. 2-butoxyethanol. Also wash solution was used as the clearing fluid rather than ethanol. As shown in rows 416, 422, 428, the hot wash solution method resulted in foamy bubbles as shown in column I or poorer staining e.g. “no blue” as shown in row 428 column I. No staining enhancement was noted, therefore it would appear that the enhancement observed in the ACS deparaffinized slides was related to the fluids used and not the temperature alone since similar temperatures were used in the how wash solution without staining enhancement.

FIG. 5 is a second special staining quality assessment 500. Four expert evaluators H, J, F, and C, evaluated the staining quality for diagnostic acceptability and for color differentiation.

Three slides deparaffinization methods were compared: xylene as shown in rows 502, 508, 514, 522, 528, 534, 542, 548, 554, 562, 568, and 574; ACS as shown in rows 504, 510, 516, 524, 530, 536, 544, 550, 556, 564, 570, and 576; and auto dry/ACS where automated drying was performed on board the special stainer prior to deparaffinization using the ACS method.

As can be seen in columns D and E, the results for the slides deparaffinized using the ACS method and the auto dry/ACS method were generally as good as the results for slide deparaffinized using xylene. In fact, as can be seen in row 524, a special stain comprising silver staining resulted in visible silver precipitate for the slide deparaffinized with xylene while less precipitation was noted in the slide deparaffinized using the ACS method as described in the comment at row 524 column F.

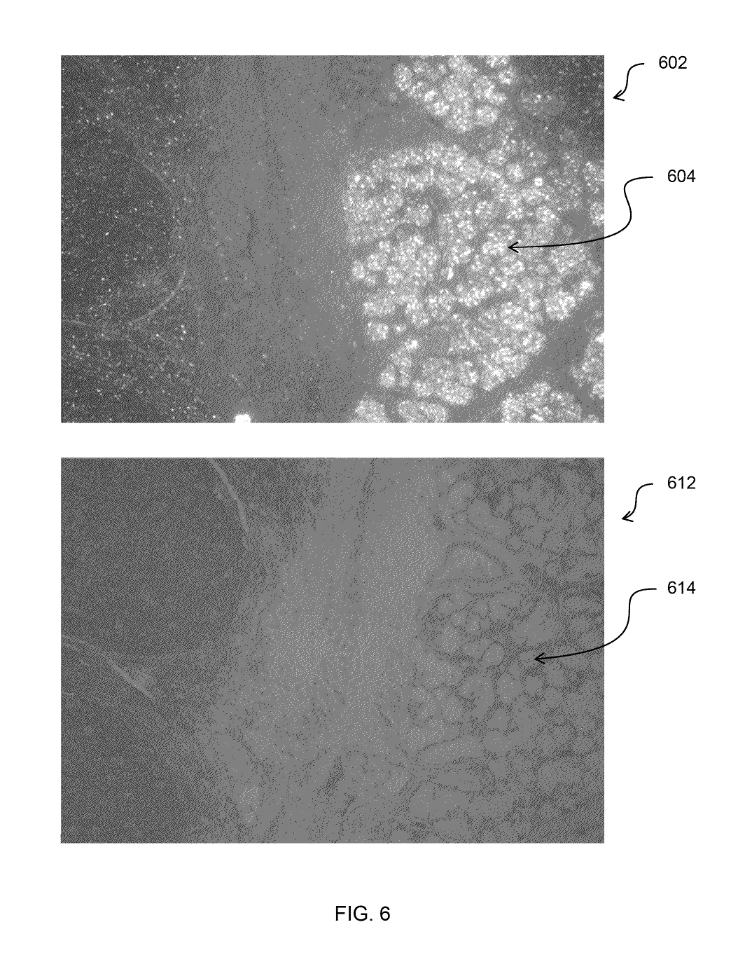

FIG. 6 are images showing tissues that were deparaffinized and stained as viewed under polarized light. As can be seen in image 602, residual paraffin is clearly observer in tissue deparaffinized using hot wash solution. This residual paraffin is visible as white or bright areas e.g. area 604.

Image 612 also taken under polarized light shows that tissue deparaffinized using the ACS method and fluids are clean without residual paraffin in area 614 which corresponds substantially to area 604 of image 602.

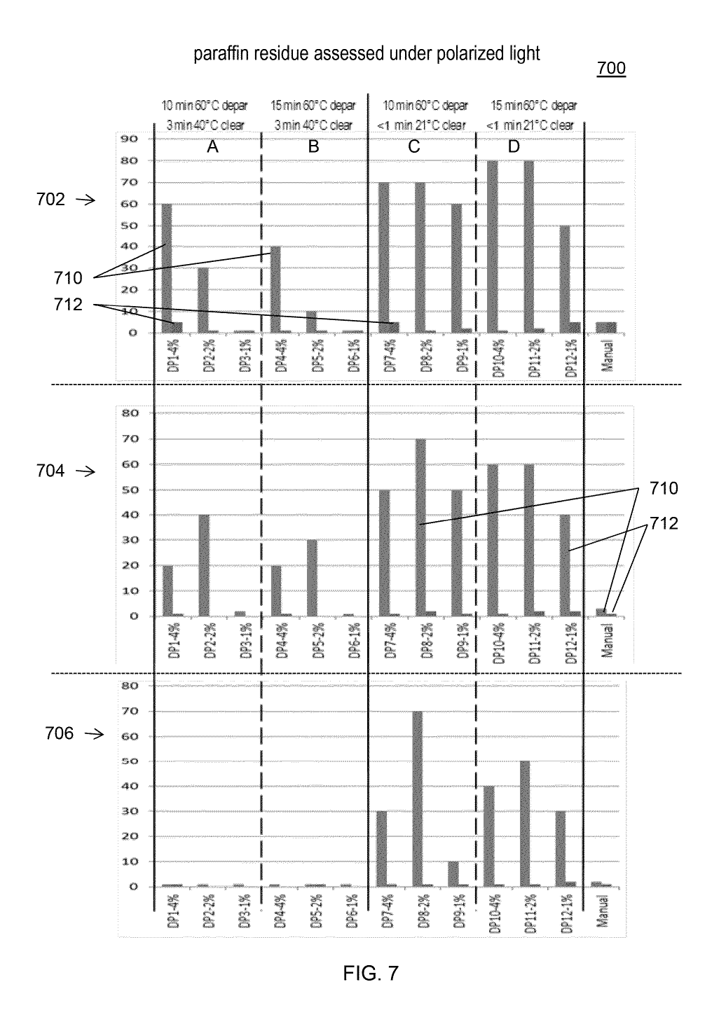

FIG. 7 shows a chart 700 comparing residual paraffin assessed in polarized light for 13 different deparaffinization protocols.

Different concentrations of water miscible paraffin solvent (e.g. 2-butoxyethanol) were tested. Different deparaffinization protocols (DP1-DP12) were tested. In DP1, DP4, DP7 and DP10 the deparaffinization fluid comprised 4% 2-butoxyethanol. In DP2, DP5, DP8 and DP11 the deparaffinization fluid comprised 2% 2-butoxyethanol. In DP3, DP6, DP9 and DP12 the deparaffinization fluid comprised 1% 2-butoxyethanol. Two vertical bars such as left hand bar 710 and right hand bar 712 which similar bars above each deparaffinization protocol show the percentage of tissue area where paraffin residue was observed. The left-hand vertical bars e.g. 710 represent paraffin observed in slides where the coverslip was mounted using the aqueous mounting method while right-hand vertical bars e.g. 712 represent the slides coverslipped using solvent mount method also known as permanent mounting. For comparison, a slide deparaffinized manually using xylene was also stained and assessed.

Tissues embedded with three different types of embedding paraffin were tested: Tissue Prep 2 row 702; Paraplast Plus row 704, and Richard Allen Type L row 706. As can be seen in chart 700 observe residual paraffin as represented by the left-hand vertical bars was generally higher in slides coverslipped using aqueous mount than in slides coverslipped using permanent or solvent mount as represented by the right-hand vertical bars. It is hypothesized that the xylene or solvent using in the permanent mount method acts to reduce the observable residue paraffin. In the case of Richard Allen Type L paraffin row 706 where heating clearing fluid was used as shown in columns A and B, very little if any paraffin residual was observed.

Temperature and timing of deparaffinization and clearing were also varied. In the group of column A, deparaffinization heating was performed as described above in FIG. 3 step 310 at a temperature of 60° C. for 10 minutes and clearing was performed as described in FIG. 3 step 318 at a temperature of 40° C. for 3 minutes. In the group of column B, deparaffinization heating was performed as described above in FIG. 3 step 310 at a temperature of 60° C. for 15 minutes and clearing was performed as described in FIG. 3 step 318 at 40° C. for 3 minutes. In the group of column C, deparaffinization heating was performed as described above in FIG. 3 step 310 at a temperature of 60° C. for 10 minutes and clearing was performed as described in FIG. 3 step 318 at ambient i.e. about 21° C. for less than 1 minute. In the group of column D, deparaffinization heating was performed as described above in FIG. 3 step 310 at a temperature of 60° C. for 15 minutes and clearing was performed as described in FIG. 3 step 318 at ambient i.e. about 21° C. for less than 1 minute.

As can be seen by comparing the aqueous mounted slides in column A with those in column B, the additional 5 minutes heating time during the depar step reduces the observed residual paraffin to a degree when a heated clearing step (e.g. ethanol wash for 3 minutes) is performed at 40° C. However additional depar heating time does not appear to make much difference when the clearing steps is unheated as shown in columns C and D.

Looking at the effect of concentration of water miscible paraffin solvent e.g. 2 butoxyethanol, it can be observed that those slides deparaffinized using 1% ACS, (i.e. ACS fluid comprise 1% 2-butoxyethanol in wash solution) followed by a 3 min 40° C. clearing step appears to have the lowest area of paraffin residue. However, although the tissue area contain polarized light observable residual paraffin was minimized with 1% ACS, more peripheral paraffin (i.e. paraffin on the slide but not on the tissue area) was observed with 1% ACS than on those slides deparaffinized using 2% ACS.

4% ACS i.e. deparaffinization fluid comprising 4% 2 butoxyethanol in wash solution (surfactant in DI water) was effective for removing paraffin but in some cases, the higher concentration of solvent resulted in tissues de-attaching from the slide. While tissue adhesion may be enhanced by using charged, adhesive, or silanized slide, these “sticky” slides are not recommended for special stains such as silver stains because the stickiness may result in residual silver precipitate.

Therefore embodiments using 2% ACS depar fluid for 10 minutes at 60° C. followed by clearing in ethanol for 3 minutes at 40° C. and subsequent clearing in ethanol and wash solution at ambient provides fast automated deparaffinization with minimal residual paraffin as shown in FIG. 7 chart 700 although other protocol may also produce acceptable results.

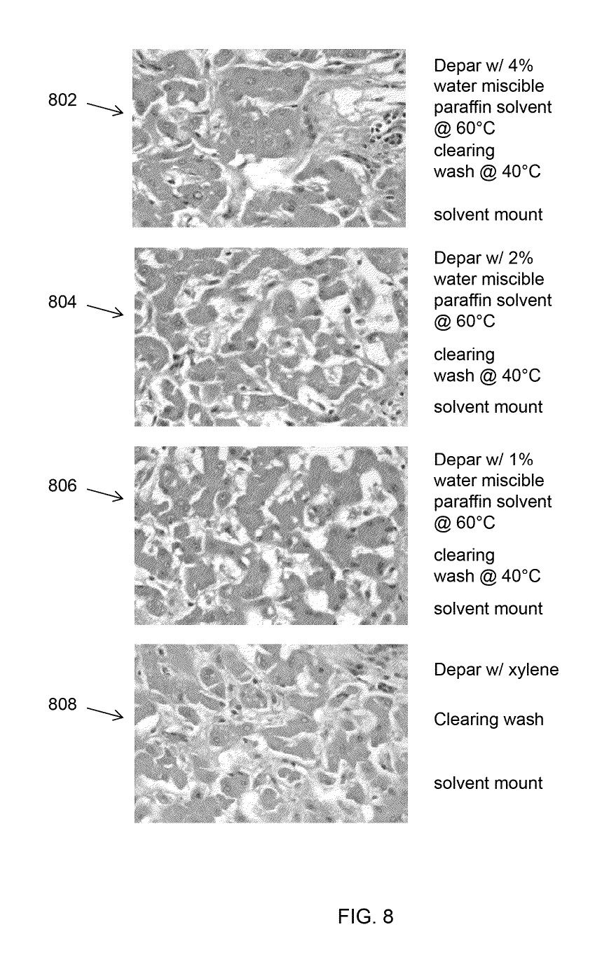

FIG. 8 compares staining quality of permanent mounted slides automatically deparaffinized using 4% ACS (image 902), 2% ACS (image 904), 1% ACS (image 906) and manually deparaffinized using xylene (image 908). No significant difference in staining quality were observed, although as previously mentioned, use of 4% ACS sometimes results in tissue detachment.

Thus the embodiments of the invention tested provided an automated method of deparaffinization for special staining that:

effectively removes paraffin from paraffin embedded tissue specimens as well as, or better than historical xylene-based manual deparaffinization as assessed by experts and illustrated in FIGS. 4-10 and described in the accompanying descriptions; results in staining quality that meets or exceeds pathologists' expectations including: clear visual differentiation of the intended target tissue component, reproducibility of staining results, minimal background, minimization of paraffin related staining artifacts as assessed by experts and illustrated in FIGS. 4-10 and described in the accompanying descriptions.

Some embodiments of the invention also minimize the number of specimens that have to be replaced and re-stained due to negative effects of extreme heating, harsh chemical solvents and aggressive agitation used to deparaffinized tissue by not using high concentration of solvents and by using a gentle method of robotically removing the paraffin e.g. aspiration.

Preferred embodiments further provide a system that facilitates easy automation of manual special staining protocol steps including staining times and temperatures without necessitating major reworking of the protocols to meet a fixed or significantly limited set of processing temperatures by providing a system and method of automated deparaffinization on a special stainer with flexible temperature and time control.

More preferred embodiments also minimize the time require for automated dewaxing resulting in a deparaffinization process that takes a little at 13 minutes compared with about 20 minutes for hot wash solution deparaffinization done off board in a waterbath.

Moreover, cost of dewaxing reagent and negative environmental and occupational, and fire hazards associated with harsh chemicals such as xylene historically used in dewaxing is reduced by using a deparaffinization fluid comprising a low concentration of water-miscible paraffin solvent such as 2% ACS rather than using xylene or other relatively harsh paraffin solvents. This also eliminates the use of dewaxing solvents that harm or deteriorate tubing, seals, gaskets and other materials otherwise suitable for fluid conveyance in an automated staining system and also minimizes the need for special stainer cleaning and maintenance to remove residues related to automated deparaffinization.

What is claimed is:

1. A method of deparaffinizing and performing special staining of paraffin embedded tissue samples comprising:
a) loading a first microscope slide comprising at least one paraffin embedded tissue sample in a horizontal position onto an automated special stainer compromising a robotic reagent dispensing carousel;
b) dispensing a covering volume of a non-buffered aqueous deparaffinization fluid comprising water and a water-miscible paraffin solvent onto said first microscope slide such that said tissue sample is covered by said deparaffinization fluid;
c) automatically controlling the temperature of said first microscope slide to a programmed temperature of between about 50° C. and about 60° C. for a programmed time of less than about 11 minutes;
d) robotically removing paraffin together with deparaffinization fluid from said tissue sample;
e) dispensing a covering volume of clearing fluid onto said first microscope slide;
f) automatically controlling temperature of said first microscope slide to a programmed temperature of between ambient and about 40° C. for a programmed time of less than about 4 minutes;
g) robotically removing said clearing fluid from said first microscope slide; and
h) staining said tissue sample by rotating said reagent dispensing carousel to a position above said tissue sample and dispensing a special staining reagent onto said tissue sample.

2. The method of claim 1 wherein said non-buffered aqueous deparaffinization fluid comprises about 2% 2-butoxyethanol.

3. The method of claim 1 wherein said clearing fluid comprises ethanol.

4. The method of claim 1 wherein said step of automatically removing paraffin together with deparaffinization fluid comprises robotically aspirating said deparaffinization fluid.

5. The method of claim 1 wherein said step of automatically removing paraffin together with deparaffinization fluid comprises spray rinsing said paraffin and deparaffinization fluid from said first microscope slide.

6. The method of claim 1, further comprising:
loading a second microscope slide onto the automated special stainer;
dispensing a cleaning fluid onto said second microscope slide; and
cleaning the automated special stainer via said cleaning fluid.

7. The method of claim 6, wherein said steps of dispensing a cleaning fluid and cleaning the automated special stainer are performed automatically at a predetermined interval.

8. The method of claim 1, further comprising mitigating evaporation of at least one of said deparaffinization fluid and said cleaning fluid.

9. The method of claim 1, wherein dispensing a covering volume of a non-buffered aqueous deparaffinization fluid includes:
dispensing a concentrated water-miscible paraffin solvent; and
dispensing a wash solution to dilute said concentrated water-miscible parrafin solvent.

10. The method of claim 1, further comprising loading a dispense pack containing said non-buffered aqueous deparaffinization fluid comprising water and a water-miscible paraffin solvent into said automated special stainer.

11. The method of claim 1, further comprising repeating steps e, f, and g at least twice prior to staining said tissue sample.

12. A method of automatically deparaffinizing and performing staining of paraffin embedded tissue samples comprising:
a) loading a first microscope slide comprising at least one paraffin embedded tissue sample in a horizontal position onto an automated special stainer compromising a robotic reagent dispensing carousel;
b) placing a fluid retaining clip onto said first microscope slide
c) dispensing a covering volume of a non-buffer aqueous deparaffinization fluid comprising water and a water-miscible paraffin solvent onto said first microscope slide such that said tissue sample is covered by said deparaffinization fluid that is retained by said fluid retaining clip;
d) automatically controlling the temperature of said first microscope slide to a programmed temperature of between about 50° C. and about 60° C. for a programmed time of less than about 11 minutes;
f) removing paraffin from said tissue sample by robotically aspirating said paraffin together with said deparaffinization fluid from said tissue sample;
g) dispensing a covering volume of clearing fluid onto said first microscope slide;
h) automatically controlling temperature of said first microscope slide to a programmed temperature of between ambient and about 40° C. for a programmed time of less than about 4 minutes;
i) robotically removing said clearing fluid from said first microscope slide
j) staining said tissue sample by rotating said reagent dispensing carousel to a position above said tissue sample and dispensing a special staining reagent onto said tissue sample.

13. The method of claim 12, wherein said non-buffered aqueous deparaffinization fluid comprises about 2% 2-butoxyethanol.

14. The method of claim 12, wherein said clearing fluid comprises ethanol.

15. The method of claim 12, further comprising:
loading a second microscope slide onto the automated special stainer;
dispensing a cleaning fluid onto said second microscope slide; and
cleaning the automated special stainer via said cleaning fluid.

16. The method of claim 15, wherein said steps of dispensing a cleaning fluid and cleaning the automated special stainer are performed automatically at a predetermined interval.

17. The method of claim 12, further comprising mitigating evaporation of at least one of said deparaffinization fluid and said cleaning fluid.

18. The method of claim 12, wherein dispensing a covering volume of a non-buffered aqueous deparaffinization fluid includes:
dispensing a concentrated water-miscible paraffin solvent; and
dispensing a wash solution to dilute said concentrated water-miscible parrafin solvent.

19. The method of claim 12, further comprising loading a dispense pack containing said non-buffered aqueous deparaffinization fluid comprising water and a water-miscible paraffin solvent into said automated special stainer.

20. The method of claim 12, further comprising repeating steps g, h, and i at least twice prior to staining said tissue sample.
